(19) United States
(12) Patent Application Publication
(10) Pub. No.: US 2013/0164450 A1
(43) Pub. Date: Jun. 27, 2013

(54) BURNISHING METHODS AND COMPOSITIONS

(71) Applicant: Terry R. Hobbs, Saint Paul, MN (US)

(72) Inventor: Terry R. Hobbs, Saint Paul, MN (US)

(73) Assignee: 3M Innovative Properties Company

(21) Appl. No.: 13/337,572

(22) Filed: Dec. 27, 2011

(51) Int. Cl. B05D 3/12; C09D 175/04

(52) U.S. Cl. 427/371; 524/507; 427/355

(57) ABSTRACT

Aqueous film-forming compositions comprising polyurethane and fugitive plasticizer; and, methods of coating such compositions onto a surface of a substrate and of burnishing the coated composition.

### BACKGROUND

Aqueous film-forming compositions are often applied to substrates such as flooring, to improve the appearance and durability of the substrate.

### SUMMARY

Herein are disclosed aqueous film-forming compositions comprising polyurethane and fugitive plasticizer; and, methods of coating such compositions onto a surface of a substrate and of burnishing the coated composition.

Thus in one aspect, herein is disclosed a method of forming a coating, comprising: coating an aqueous film-forming composition comprising 15 to 100 dry weight percent polyurethane and comprising 1 to 12 wet weight percent fugitive plasticizer, onto a surface of a substrate to form a first coating thereupon; and, allowing the coating to dry; then, burnishing the first coating within sixty minutes of forming the first coating.

Thus in another aspect, herein is disclosed an aqueous film-forming composition comprising 15 to 85 dry weight percent polyurethane, 15 to 85 dry weight percent acrylic polymer at a weight ratio of between 1:5 and 5:1 with the polyurethane, and 1 to 12 wet weight percent fugitive plasticizer.

These and other aspects of the invention will be apparent from the detailed description below. In no event, however, should the above summaries be construed as limitations on the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary coating as disclosed herein.

FIG. 2 is a side schematic cross sectional view of an exemplary coating with a second coating thereupon.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, bottom”, “upper”, lower”, “under”, “over”, “front”, “back”, “outward”, “inward”, “up” and “down”, and “first” and “second” may be used in this disclosure, it should be understood that those terms are used in their relative sense only unless otherwise noted.

### DETAILED DESCRIPTION

### Glossary

By aqueous film-forming composition is meant any coatable aqueous dispersion, emulsion, etc., comprising at least one film-forming polymer therein.

By film-forming is meant that when coated, at or near 20° C., onto a surface as part of an aqueous composition, a polymer is capable, upon removal of the water and any other volatile components from the composition, of coalescing to form a dense polymeric film layer.

By burnishing a coated aqueous film-forming composition is meant contacting a major outwardmost surface of the coated composition with a fibrous pad that is moving at a high speed (at least 1000 revolutions per minute in a rotating format, or an equivalent speed if in a reciprocating format), driven by a motorized apparatus.

By wet weight percent of an ingredient is meant the percentage of the total wet weight of an aqueous film-forming composition that is provided by that ingredient.

By dry weight percent of an ingredient is meant the percentage of the total dry weight of a film obtained from coating and drying of an aqueous film-forming composition, provided by that ingredient (i.e., in the absence of volatile ingredients that are removed during drying of the film).

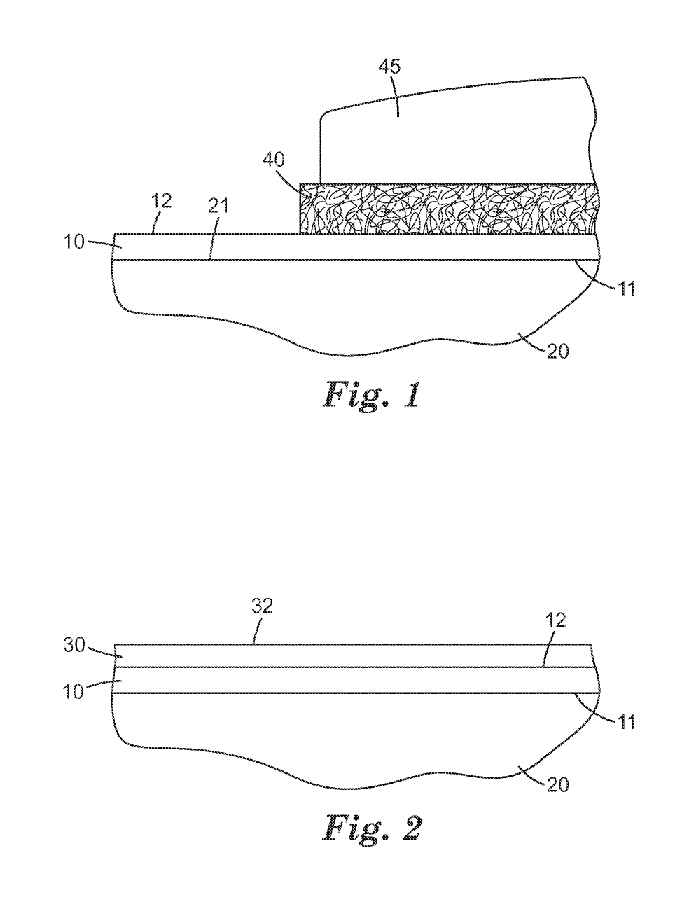

The disclosures herein are discussed with reference to FIGS. 1 and 2. Shown in FIG. 1 is a side schematic cross sectional view of an exemplary aqueous film-forming composition, after having been coated onto a major surface 21 of a substrate 20 so as to form a (first) coating 10. Coating 10 comprises first major surface 11 that faces major surface 21 of substrate 20, and second, outwardmost major surface 12 that may be burnished as disclosed herein.

The aqueous-film forming composition comprises one or more film-forming polymers, e.g. in the form of an emulsion or dispersion as discussed later herein. The film-forming polymer(s) comprise at least polyurethane or polyurethane-acrylic hybrid, which those of ordinary skill will appreciate as providing enhanced properties (e.g., abrasion resistance) to a resulting dried film. However, those of ordinary skill will also appreciate that polyurethanes may comprise a glass transition temperature (T_{g}) that is relatively far above 20° C. Thus, it may be desirable to include plasticizer(s) in the aqueous film-forming composition so as to lower the T_{g} of the polyurethane such that it may acceptably form a film at room temperature (since coatings are typically applied to surfaces (such as floors) and dried thereon, at such temperatures). Accordingly, the aqueous film-forming composition as disclosed herein comprises fugitive plasticizer (with the term fugitive meaning that substantially all of the plasticizer eventually evaporates from the coated composition). However, it will be appreciated that such fugitive plasticizers (as exemplified by e.g. certain glycol ethers and the like, as discussed in detail later herein) may be relatively slow to evaporate and as such can result in a long drying time being required after the coating of the aqueous film-forming composition, before another coating can be applied thereupon. Thus, multiple coatings of polyurethane-containing coating compositions have conventionally not been able to be applied as rapidly and frequently as coating compositions (e.g. acrylic-based compositions) that do not contain polyurethanes.

As disclosed herein, it has been found that the coalescing and hardening of the herein-described coated composition containing polyurethane and fugitive plasticizer, and/or the removal of fugitive plasticizer, can be promoted and accelerated if the composition is burnished soon after being coated; e.g., after the coated composition is allowed to dry. (Such burnishing can be achieved e.g. with a suitable fibrous pad 40 that is contacted with outwardmost surface 12 of coating 10 and, while in contact therewith, is moved relative thereto at high speed by motorized apparatus 45, as shown in FIG. 1.) By “dry” is meant dry to the touch, without being sticky or tacky, which concept will be well understood by those of ordinary skill. This dry condition will typically be reached within 60 minutes, 40 minutes, 30 minutes, or even 15 minutes from the time of coating, depending e.g. on the temperature and humidity. It will be understood that this dry condition does not require that substantially all water and/or fugitive plasticizer has been removed from the coated composition; rather, it merely implies that the coated composition is sufficiently dry for the herein-described burnishing process to be successfully performed without the coated composition being so wet and sticky as to adhere to the fibers of the burnishing pad, to generate gross cosmetic defects in the coated layer, etc.

Without being limited by theory or mechanism, it may be that the burnishing process may generate heat so as to increase the evaporation rate of fugitive plasticizer; may mechanically work (deform) the polyurethane particles (which may still be at least somewhat soft and swollen by the fugitive plasticizer) so as to increase the evaporation rate of the fugitive plasticizer; and, may physically impinge the polyurethane particles together through mechanical force exerted by the pad. Any or all of these may accelerate the process of liberating and evaporating the fugitive plasticizer and coalescing the polyurethane particles to form a film.

Thus in use of the methods and compositions disclosed herein, a first polyurethane-containing aqueous film-forming composition (e.g., 10) can be coated, and can be burnished soon thereafter so that another polyurethane-containing aqueous film-forming composition (e.g., coating 30 as shown in FIG. 2) can be coated thereupon relatively soon (e.g., within one hour of the coating of the first aqueous film-forming composition). Two such coatings (layers) often providing an ideal compromise between application time and properties achieved, a satisfactory overall (multilayer) coating (e.g., with excellent hardness, durability, gloss, etc.) may thus be quickly and easily obtained. Significantly, and in contrast to conventional floor finishes such as e.g. polyurethane-free acrylic finishes, finishes that comprise condensable/crosslinkable silicates, and so on, it has been found that it is not necessary to burnish the second polyurethane-containing coating (specifically, with regard to FIG. 2, it is not necessary to burnish outwardmost surface 32 of second coating 30) in order to achieve such properties. Thus, additional time and expense can be saved. It will still further be understood that achieving high gloss levels as disclosed herein, with only e.g. two coatings, can reduce the chances of defects that sometimes occur in the coating of numerous (e.g., four or more) layers. That is, the ordinary artisan will appreciate that with e.g. four or more coated layers, the collective amount of residual volatile components diffusing upward through the outermost layers may make it more likely for cosmetic defects and the like to occur. In addition, the burnishing process can be used to minimize or remove coating defects such as application marks, haze, or streaks.

The methods and compositions disclosed herein thus provide significant advantages over conventional methods and compositions. Properties and attributes of the aqueous film-forming compositions and components thereof, of burnishing pads, apparatus, methods, etc., will now be discussed in further detail.

Burnishing of a coated aqueous film-forming composition may be performed by contacting a major outwardmost surface of the coating with a suitable fibrous pad that is moving relative to the coated aqueous film-forming composition at high speed (again, as defined above, at at least 1000 RPM or the reciprocating equivalent). Such speeds may correspond to a linear velocity of the pad (e.g. at or near an edge of the pad) relative to the coating, of at least e.g. 100 kilometers per hour. In various embodiments, burnishing may be performed with a pad rotation of at least 1500, 2000, or 2500 RPM. In further embodiments, burnishing may be performed such that the linear velocity of at least edge portions of a pad are at least 150, 200, or 250 kilometers per hour. Burnishing often involves multiple passes (e.g., four, six, eight, or more), e.g. back and forth over a given area of substrate, in order to enhance the uniformity of the burnishing. Any suitable fibrous pad (comprised e.g. of nonwoven fibers, optionally comprising particles, e.g. abrasive particles of any suitable type or composition), that can withstand the forces involves in such high-speed rotation, may be used for burnishing. Suitable pads include the products available from 3M Company, St. Paul, Minn., under the trade designations TOPLINE SPEED BURNISH 3200, ERASER BURNISH 3600, AQUA BURNISH 3100, TAN BURNISH 3400, WHITE SUPER POLISH 4100, NATURAL BLEND WHITE 3300, and NATURAL BLEND TAN 3500. In particular embodiments a fibrous pad may comprise diamond particles, as in the products available from 3M Company under the trade designations SCOTCH-BRITE SIENNA DIAMOND FLOOR PAD PLUS, and SCOTCH-BRITE PURPLE DIAMOND FLOOR PAD PLUS. (It will be noted that due to varying nomenclature, not all such suitable pads may be labeled by the supplier as “burnishing” pads.)

Burnishing can be performed with the use of any motorized burnishing apparatus to which a suitable fibrous pad may be mounted and which is capable of driving the pad at high speeds as described above, whether such apparatus is e.g. electrically powered (whether by cord or battery), or e.g. propane-powered. Such apparatus may comprise an adjustable rate of rotation, and may also (e.g., by virtue of the weight of the apparatus) apply relatively high pressure to the backside of the fibrous pad to hold it firmly against the surface to be burnished. Such apparatus may optionally be configured to heat the surface to be burnished, in additional to driving the fibrous pad. Potentially suitable burnishing apparatus are widely available from various sources and are described in general e.g. in U.S. Pat. Nos. 4,731,895, and 7,137,876.

Burnishing is performed dry; that is, without depositing any liquid onto the surface to be burnished, and without the fibrous pad comprising any liquid incorporated therein. Thus, burnishing can be distinguished from e.g. operations such as stripping, cleaning, scrubbing, etc., that are performed with the use of (liquid) stripping solutions, cleaning solutions, and so on. Moreover, as a high speed process, burnishing is distinguished from operations such as buffing, e.g. spray buffing, which, even though they may sometimes be performed dry, are performed at low speeds (e.g., 150-600 RPM). It is also noted that the herein-described burnishing of a freshly coated and not yet dried aqueous film-forming composition (e.g., within one hour of being coated), is distinguished from the common practice that conventional floor finishes, days or even weeks after being coated (that is, after being subject to use and wear), may be subjected to (repeated, e.g. daily) burnishing so as to restore high gloss. It is still further noted that burnishing of freshly coated conventional (e.g., non-polyurethane-containing) floor finishes for the purpose of e.g. promoting chemical crosslinking of organic binders (e.g., crosslinkable acrylic binders) and/or promoting crosslinking and condensation of inorganic densifiers such as silicates, is distinguished from the burnishing of e.g. a coated aqueous film-forming composition that comprises a polyurethane for purposes of accelerating the removal of fugitive plasticizer from the coated composition and promoting coalescence of the polyurethane as disclosed herein.

In the exemplary embodiment described above, a first polyurethane-containing aqueous film-forming composition is applied to a surface (e.g., to form a first, e.g. base, coating), and is then burnished, after which a second polyurethane-containing aqueous film-forming composition is applied atop the first coat. In some embodiments, this second coating may be a final coating (e.g., a top coating, which may provide e.g. a wear layer). In such a case, it is not necessary to burnish the second coating (e.g., to achieve excellent gloss, abrasion resistance, etc., of the resulting film) although this may be optionally done. In other embodiments, a third polyurethane-containing coating may be applied atop the second coating. If so, the second coating may be burnished in similar manner as the first. Similarly, the third coating may be a top coating and may not need to be burnished; or, it may be burnished and then one or more additional layers successively coated thereupon, with burnishing being performed in between coating operations as described above. Regardless of the number of layers, however, it is not necessary to burnish the final top (outwardmost) coating, although this can be optionally done. For example, burnishing may serve to at least slightly temporarily heat the final top coating, if this is desired.

The various coatings may differ in composition (e.g., the amount of polyurethane, the structure of the polyurethane, amount of fugitive plasticizer, etc.); however, it may be convenient to use same aqueous film-forming composition for each coating.

In the exemplary embodiment described above, the first coating is coating directly onto major surface 21 of substrate 20. In some cases, e.g. if substrate 20 comprises an existing coating thereupon that has not been removed, first major surface 11 of coating 10 may contact an outwardmost surface of this coating, rather than directly contacting major surface 12 of substrate 20. In some embodiments, an existing coating may be stripped (e.g., by a chemical stripper according to well-known methods) to remove at least a portion, or substantially all, of an existing coating, prior to the coating of the above-described first aqueous film-forming composition.

In some embodiments first major surface 21 of substrate 20 may itself be burnished prior to the coating of the above-described first aqueous film-forming composition. Although such burnishing may not necessarily impact the drying and coalescing of the applied first aqueous film-forming composition, it may enhance the gloss of the substrate itself. However, it has been found that the above-described burnishing of the first coated aqueous film-forming composition often (particularly in the case of substrates with somewhat irregular (non-planar) surfaces) results in at least some burnishing of the substrate itself with resulting gloss enhancement, without requiring a separate pre-burnishing of the substrate. This represents yet another advantage of the disclosures herein.

In some embodiments, one or more pads may be used in the burnishing process. A particularly useful sequence is to first burnish the coating with a more aggressive pad (e.g., 3M PURPLE DIAMOND PAD or 3M NO. 3300 NATURAL BLEND WHITE PAD) followed by burnishing the coating with a less aggressive pad such as 3M NO. 4100 WHITE SUPER POLISH PAD. It has been found that such a burnishing sequence may provide an enhanced gloss. It will be appreciated by those skilled in the art that any suitable pads may be used or substituted in this described process of burnishing with a more aggressive pad followed by burnishing with a less aggressive pad. (In this context, those of ordinary skill will appreciate that more aggressive means comprising a greater amount of abrasive particles, and/or comprising abrasive particles that are harder and/or of a shape, so as to provide a higher capability to mechanically work a surface).

A burnishable aqueous film-forming composition as disclosed herein comprises at least film-forming polyurethane and fugitive plasticizer. The aqueous film-forming composition may optionally comprise other film-forming polymers such as e.g. acrylic polymer. The aqueous film-forming composition may also optionally comprise wax, and/or various other ingredients for various purposes, as discussed below.

Any suitable polyurethane may be used as long as it is capable of forming a film, either alone or in combination with any other film-forming polymer. In various embodiments, polyurethane may be present in the aqueous film-forming composition at an amount corresponding to a dry weight percentage (after coating and drying of the composition into a film) of at least 15 percent, 25 percent, or 30 percent. In further embodiments, polyurethane may be present at a dry weight percentage of at most 100 percent, 95 percent, 85 percent, 65 percent, 55 percent, or 45 percent. In various embodiments, polyurethane may be present in the aqueous film-forming composition at a wet weight percentage of at least 3 percent, 5 percent, or 7 percent. In further embodiments, polyurethane may be present at a wet weight percentage of at most 25 percent, 15 percent, or 9 percent.

Suitable polyurethanes may be of any desired structure, e.g. derived from any appropriate isocyanate-containing monomer, oligomer, prepolymer, etc., and chain extender (polyol, polyamine, etc.). Those familiar with the art of polyurethanes will appreciate that the term encompasses polymers having e.g. urethane linkages, urea linkages, and urethane-urea linkages, depending e.g. on whether an active hydrogen-containing material from which the polyurethane is derived is e.g. polyhydroxy, polyamino, or combination thereof.

Suitable polyurethanes may be aromatic or aliphatic, polyester-based or polyether-based, and so on, as will be well-appreciated by the ordinary artisan. It is likewise well known that aliphatic polyurethanes may offer enhanced non-yellowing, which may be advantageous in some applications. A single polyurethane may be used; or, mixtures of two or more polyurethanes (e.g., of different compositions) may be used, in which case the above-presented percentages apply to the combined total of the polyurethanes. In addition a polyurethane-acrylic hybrid polymer (e.g., copolymer) may be used. These are well known in the art and may be formed e.g. by adding an acrylic monomer to a polyurethane dispersion followed by radical polymerization of the monomer.

In some embodiments polyurethane(s) may be conveniently obtained e.g. as an aqueous emulsion or dispersion, in which form it may be mixed with various other ingredients to form the aqueous film-forming composition. Representative polyurethane dispersions include e.g. various materials available from Alberdingk Boley Gmbh (Krefeld, Germany) under the trade designations ALBERDINGK Uxxxx or from Bayer Materials Science, Pittsburg, Pa. under various trade designations. Suitable polyurethane acrylic-hybrids are available from Alberdingk Boley and from Air Products, Inc., Allentown, Pa. under the trade designation HYBRIDUR.

In some embodiments the polyurethane may be nonreactive, so that it is at its final molecular weight as present in the aqueous film-forming composition. That is, upon being coated and forming a film, only physical coalescence of polyurethane particles, and evaporation of volatile components, may occur. In other embodiments the polyurethane may be reactive as present in the aqueous film-forming composition, meaning that it may comprise at least some cross-linking ability (e.g., as provided by groups and/or functionalities such as isocyanate, aziridine, etc.), as will be well understood by the ordinary artisan. In such cases the drying of the coated film may be accompanied by at least some crosslinking and commensurate build-up of the molecular weight of the polyurethane. In such cases, a crosslinking agent may be mixed into the aqueous film-forming composition prior to application and burnishing. In other embodiments, the urethane may contain latent reactive chemistry and may be self-crosslinking

Any suitable fugitive plasticizer may be used in the aqueous film-forming composition. It will be appreciated that many such fugitive plasticizers may serve not only to plasticize the polyurethane in order to lower its T_{g} to enhance the film-forming properties thereof, but may also serve other purposes in the aqueous film-forming composition. That is, such a fugitive plasticizer may serve to modify (e.g., lower) the viscosity of the aqueous film-forming composition, to help stabilize the dispersion of e.g. polyurethane particles in the aqueous film-forming composition, to compatibilize various ingredients of the aqueous film-forming composition, and so on. In some embodiments, it may be preferred that a fugitive plasticizer be water-miscible (e.g., so that the fugitive plasticizer is water-soluble at least to the level of 5 grams plasticizer per 100 grams of water).

The term fugitive plasticizer was defined above as meaning that substantially all of the plasticizer eventually evaporates from the coated composition. This does not preclude a low, but detectable, level of fugitive plasticizer (e.g., less than 0.2 dry weight percent) from being present in the film, e.g. two weeks after the film is coated. However, such fugitive plasticizer is readily distinguishable from a permanent plasticizer, as described later herein.

In various embodiments, fugitive plasticizer may be present in the aqueous film-forming composition at a wet weight percentage of at least 1 percent, 2 percent, 3 percent, 4 percent, or 5 percent. In further embodiments, the fugitive plasticizer may be present at a dry weight percentage of at most 12 percent, 9 percent, 7 percent, or 6 percent.

Various materials in the family of organic compounds commonly known as glycol ethers may be particularly suitable for use as fugitive plasticizer. Such materials may include e.g. ethylene glycol methyl ether, ethylene glycol ethyl ether, ethylene glycol monobutyl ether, ethylene glycol-2-ethylhexyl ether, propylene glycol, propylene glycol methyl ether, propylene glycol ethyl ether, propylene glycol monobutyl ether, propylene glycol-2-ethylhexyl ether, diethylene glycol, diethylene glycol methyl ether, diethylene glycol ethyl ether, diethylene glycol monobutyl ether, diethylene glycol-2-ethylhexyl ether, dipropylene glycol, dipropylene glycol methyl ether, dipropylene glycol propyl ether, dipropylene glycol monobutyl ether, dipropylene glycol-2-ethylhexyl ether, and mixtures thereof. Such materials are available e.g. from Dow Chemical, Midland, Mich., under trade designations such as DOWANOL, CARBITOL, and CELLOSOLVE. Other materials potentially suitable for use as fugitive plasticizer include e.g. isophorone, benzyl alcohol, 3-methoxy-1-butanol.

The aqueous film-forming composition may optionally include any suitable film-forming polymer in addition to the polyurethane. In various embodiments, additional film-forming polymer may be present in the aqueous film-forming composition at an amount corresponding to a dry weight percentage (after coating and drying of the composition into a film) of at least 25 percent, 35 percent, or 40 percent. In further embodiments, additional film-forming polymer may be present at a dry weight percentage of at most 85 percent, 55 percent, or 50 percent. In various embodiments, additional film-forming polymer may be present in the aqueous film-forming composition at a wet weight percentage of at least 5 percent, 7 percent, or 9 percent. In further embodiments, additional film-forming polymer may be present at a wet weight percentage of at most 27 percent, 20 percent, or 13 percent. In some embodiments, additional film-forming polymer may be present at a weight ratio, relative to polyurethane, of at least 1:4, 1:3, 1:1.5, 1:1, or 3:1. In further embodiments, additional film-forming polymer may be present at a weight ratio, relative to polyurethane, of at most 6:1, 4:1, 2:1, or 1.6:1. A single additional film-forming polymer may be used; or, mixtures of two or more such polymers (e.g., of different compositions) may be used, in which case the above-presented percentages and ratios apply to the combined total of the polymers.

In some embodiments, an additional film-forming polymer may be conveniently obtained e.g. as an aqueous emulsion or dispersion, in which form it may be mixed with various other ingredients to form the aqueous film-forming composition.

In particular embodiments, an additional film-forming polymer is a self-crosslinking polymer, which the ordinary artisan will recognize as comprising crosslinkable groups or functionalities such as e.g. aziridine, acrylamide, carbodiimide, hydrazide, and the like, such that the additional polymer builds in molecular weight during drying of the coated composition.

In certain embodiments, an additional film-forming polymer may comprise moieties which render it capable of e.g. reversible crosslinking, so that e.g. a coated and dried aqueous film-forming composition can be more easily stripped at some future time, upon exposure to a suitable chosen stripping agent. In some embodiments, acid-containing monomers may be included if some alkali strippability is desired.

Acrylic polymers may be particularly useful as additional film-forming polymers. For convenience of description, the term acrylic as used herein will be understood to encompass both acrylic and methacrylic polymers. Any suitable acrylic polymer may be used, which category thus encompasses acrylic polymers, methacrylic polymers, acrylic copolymers, methacrylic copolymers, and copolymers and mixtures and blends of any of these. Such polymers and/or copolymers may be made from any suitable acrylic monomers, representative examples of which include acrylic acid, butyl acrylate, ethyl acrylate, methyl acrylate, 2-ethyl hexyl acrylate, acrylonitrile, acrylamide, methacrylic acid, methyl methacrylate, ethyl methacrylate, butyl methacrylate, methacrylamide, and the like. Such acrylic polymers or copolymers may also comprise some styrenic content (e.g., in the case of acrylic-styrenic copolymers), epoxy content (e.g. in the case of acrylic-epoxy copolymers), and so on. Representative acrylic film-forming copolymers that may be suitable include, but are not limited to, methyl methacrylate/butyl acrylate/methacrylic acid copolymers, methyl methacrylate/butyl acrylate/acrylic acid copolymers, and the like.

In particular embodiments, an acrylic polymer is a self-crosslinking polymer, which the ordinary artisan will recognize as comprising crosslinkable groups or functionalities e.g. as described above.

In some embodiments, additional film-forming polymer may be conveniently obtained e.g. as an aqueous emulsion or dispersion, in which form it may be mixed with various other ingredients to form the aqueous film-forming composition. Representative acrylic polymers suitable for use as additional film-forming polymers include various acrylic emulsions available from Alberdingk Boley under the trade designation ALBERDINGK; available under the trade designations RHOPLEX and DURAPLUS from the Rohm and Hass subsidiary of Dow Chemical, Midland, Mich.; available from BASF SE, Ludwigshafen, Germany, under the trade designation JONCRYL; and available from DSM NeoResins, Heerlen, The Netherlands, under the trade designation NEOCRYL.

The aqueous film-forming composition may includes other polymeric materials that may not necessarily be of sufficient molecular weight to be film-forming on their own, but that may, when added to the aqueous film-forming composition, provide beneficial properties to the final dried film. Such materials, which may impart such properties to the dried film as e.g. anti-slip, black heel mark resistance, scratch resistance, water resistance, and so on, will be grouped herein under the general designation of waxes (which includes materials that may be of such low molecular weight that they are semi-solid or semi-liquid at 20° C.). Waxes or mixtures of waxes which may be used include materials of vegetable, animal, petroleum, and/or mineral derived origin. Representative waxes include carnauba wax, candelilla wax, oxidized Fischer-Tropsch wax, microcrystalline wax, lanolin; bayberry wax, palm kernal wax, mutton tallow wax, emulsifiable polyethylene wax, polyethylene copolymer wax, emulsifiable petroleum derived waxes, montan wax derivatives, emulsifiable polypropylene wax, oxidized polyethylene wax, and the like.

In various embodiments, such optional waxes (whether a single material or a mixture of materials), if present, may be provided in the aqueous film-forming composition at a level of at least 2, 3 or 6 dry weight percent. In further embodiments, such optional waxes may be provided at a level of at most 25, 15, or 10 dry weight percent.

In some embodiments, materials in the general category of waxes may be conveniently obtained as aqueous emulsions or dispersions in which form they may be mixed with various other ingredients to form the aqueous film-forming composition. Suitable materials which fall under this general category include those materials available from Michelman, Blue Ash, Ohio under the trade designations MICHEM EMULSION 94340, MICHEM EMULSION 44730, AND MICHEM LUBE 190.

If desired, permanent plasticizer may be optionally included in the aqueous film-forming composition, with the term permanent plasticizer being distinguished from a fugitive plasticizer as denoting an ingredient that substantially remains in the coated and dried film even days or weeks after the coating and drying of the film (e.g., such that at least 90 weight % of the original amount of plasticizer is still present in the dried film at one week time). Examples of ingredients that may serve as permanent plasticizers include butyl benzyl phthalate, dibutyl phthalate, dimethyl phthalate, triphenyl phosphate, 2-ethylhexyl benzyl phthalate, butyl cyclohexyl phthalate, mixed benzoic acid and fatty oil acid esters of pentaerythritol, polypropylene adipate) dibenzoate, diethylene glycol dibenzoate, tetrabutylthiodi-succinate, butyl phthalyl butyl glycolate, triethyl citrate, acetyl triethyl citrate, tributyl citrate, acetyl tributyl citrate, dibenzyl sebacate, tricresyl phosphate, tributoxyethyl phosphate, toluene ethyl sulfonamide, the di-2-ethylhexyl ester of hexamethylene glycol diphthalate, di-(methylcyclohexyl)-phthalate, and tributyl phosphate. In various embodiments, such optional permanent plasticizer (whether a single material or a mixture of materials), if present, may be provided in the aqueous film-forming composition at from 1-20, 2-10, or 3-6 dry weight percent.

In some embodiments, tributoxyethyl phosphate (TBEP) may be included in the aqueous film-forming composition, which ingredient may serve as a plasticizer and also may act as a leveling agent. In various embodiments, this optional ingredient may be provided in the aqueous film-forming composition at between 0.2-7, 0.5-5, or 1-3 wet weight percent. In some particular embodiments, substantially no (meaning less than about 0.2% wet weight percent) permanent plasticizer is present in the aqueous film-forming composition with the exception of tributoxyethyl phosphate.

In some embodiments, a permanent plasticizer may not be needed. For example, some hard coatings on concrete, stone or hardwoods may not require a permanent plasticizer. In such embodiments, the only plasticizer that may be present may be the above-described fugitive plasticizer.

The aqueous film-forming composition may contain a variety of other ingredients that will be familiar to persons having ordinary skill in the art. Such ingredients which may be included in various embodiments may include, but are not limited to, surfactants (e.g., silicone surfactants, nonionic surfactants, anionic surfactants, and cationic surfactants), emulsifiers, pH modifiers, pigments, mineral fillers, colorants, dyes, dispersants, defoamers, thickeners, heat stabilizers, wetting agents, leveling agents, coalescents, biocides, mildewcides, anti-cratering agents, fillers, sedimentation inhibitors, ultraviolet light absorbers, optical brighteners, antioxidants, catalysts, flow agents, and crosslinking agents. In other embodiments, any of these individual ingredients, or any combination of any of these ingredients, may be specifically excluded from the aqueous film-forming composition.

In particular embodiments, the aqueous film-forming composition may include surface modified inorganic nanoparticles that have an average particle size (diameter) of 5-150 nm and that are surface modified with coupling agents on the surface thereof Such nanoparticles are described in detail in U.S. Pat. No. 6,727,309, to Paiva et al., which is incorporated by reference herein. In alternative embodiments, substantially no such inorganic nanoparticles are present in the aqueous film-forming composition. In various embodiments, such nanoparticles may comprise surface modified zinc oxide, aluminum oxide, or silicone dioxide.

In some embodiments, the aqueous film-forming composition contains substantially no condensable or crosslinkable silicates or condensable or crosslinkable polysilicates.

Water (in addition to that which may be present in various ingredients, e.g. emulsions or dispersions), may be added to the aqueous film-forming composition e.g. so as to bring it to an optimum state (e.g., of viscosity) for coating. In various embodiments, the total solids content of all of the nonvolatile ingredients of the aqueous film-forming composition may be at least 8, 10, or 15 weight percent. In further embodiments, the total solids content of the coating may be at most 35, 25, or 20 weight percent.

Many ingredients have been listed herein as being optionally included in an aqueous film-forming composition in some embodiments. However, it is noted that in any embodiment, any such optional ingredient may be specifically excluded, meaning that substantially none of the component is present in the formulation. It will also be understand that terms such as substantially no and substantially none, as used here and elsewhere herein, do not preclude the presence of some low level of material, as may occur e.g. when using large scale production equipment subject to customary cleaning procedures. Thus, such terms should be understood to mean less than 0.2% wet weight percentage unless specifically otherwise indicated.

The aqueous film-forming composition may be coated upon the surface of any suitable substrate. The substrate may comprise a bare surface (that may be of similar or the same composition as the bulk thickness of the substrate); or the surface may be primed or otherwise treated, prior to coating of the aqueous film-forming composition. As mentioned, an existing coating (e.g., finish) may be partially or completely stripped from the substrate prior to coating of the aqueous film-forming composition. The substrate may comprise a unitary structure; or, it may comprise a multilayer (e.g., composite) structure. In particular embodiments, the substrate is flooring.

In some embodiments, the substrate is a vinyl substrate, including e.g. vinyl composite tile (VCT), commonly known as vinyl floor tile; continuous vinyl sheeting, also called sheet vinyl; and the like. In other embodiments, the substrate is wood (whether solid or veneer). In such embodiments, the wood may be optionally treated (e.g., primed, sanded, sealed, etc., e.g. in order to minimize bleed-through of tannins) prior to coating of the aqueous film-forming composition. In some embodiments, the substrate is stone, concrete, or terrazzo. In such cases, the burnishing may be performed with fibrous pads that are particularly well suited for concrete (e.g., pads comprising diamond particles). In some embodiments, the substrate is chosen from marble, ceramic, and stone materials.

The aqueous film-forming composition may be coated onto a major surface of the substrate using any suitable method (e.g. by mopping, spraying, pouring, squeegeeing, brushing, etc., whether performed manually or with the use of powered apparatus). A preferred method of application is by using a flat mop system. Such systems are commercially available from 3M Company under the trade designation EASY SHINE. The composition may be coated to any desired wet thickness, e.g. up to 400, 200, or 100 microns; and, depending e.g. on the % solids of the film-forming polymers and any other nonvolatile ingredients, may provide a final dry thickness of e.g. up to 25, 50, or 100 microns.

### List of Exemplary Embodiments

Embodiment 1. A method of forming a coating, comprising: coating an aqueous film-forming composition comprising 15 to 100 dry weight percent polyurethane and comprising 1 to 12 wet weight percent fugitive plasticizer, onto a surface of a substrate to form a first coating thereupon; and, allowing the coating to dry; then, burnishing the first coating within sixty minutes of forming the first coating.

Embodiment 2. The method of embodiment 1 further comprising the step of coating an aqueous film-forming composition comprising 15 to 100 dry weight percent polyurethane and comprising 1 to 12 wet weight percent fugitive plasticizer, onto an outwardmost surface of the burnished first coating, to form a second coating thereupon.

Embodiment 3. The method of embodiment 2 wherein the aqueous film-forming composition of embodiment 2 is of the same composition as the aqueous film-forming composition of embodiment 1.

Embodiment 4. The method of any of embodiments 2-3 with the proviso that the second coating is not burnished and is a top coating with no other coatings being formed thereupon.

Embodiment 5. The method of any of embodiments 2-3 further comprising the step of burnishing the second coating.

Embodiment 6. The method of embodiment 5 further comprising the step of forming a top coating directly or indirectly upon the burnished second coating, with the proviso that the top coating is not burnished.

Embodiment 7. The method of any of embodiments 1-6 comprising the step of burnishing the surface of the substrate before coating the aqueous film-forming dispersion thereupon to form the first coating.

Embodiment 8. The method of any of embodiments 1-7 further comprising the step of at least partially stripping a finish from the surface of the substrate before coating the aqueous film-forming dispersion thereupon to form the first coating.

Embodiment 9. The method of any of embodiments 1-8 wherein the burnishing includes at least one step of burnishing the first coating with a fibrous pad comprising diamond particles.

Embodiment 10. The method of any of embodiments 1-9 wherein the burnishing includes at least one step of burnishing the first coating at least at 1500 RPM.

Embodiment 11. The method of any of embodiments 1-10 wherein the aqueous film-forming composition comprises 25 to 95 dry weight percent polyurethane.

Embodiment 12. The method of any of embodiments 1-11 wherein the aqueous film-forming composition comprises 30 to 65 dry weight percent polyurethane.

Embodiment 13. The method of any of embodiments 1-12 wherein the aqueous film-forming composition comprises 25 to 85 dry weight percent acrylic polymer at a weight ratio of between 1:4 and 4:1 with the polyurethane.

Embodiment 14. The method of embodiment 13 wherein the acrylic polymer is a self-crosslinking acrylic polymer.

Embodiment 15. The method of any of embodiments 1-14 wherein the aqueous film-forming composition comprises 35 to 55 dry weight percent acrylic polymer at a weight ratio of between 1:1.5 and 2:1 with the polyurethane.

Embodiment 16. The method of any of embodiments 1-15 wherein the aqueous film-forming composition comprises 40 to 50 dry weight percent acrylic polymer at a weight ratio of between 1:1 and 1.6:1 with the polyurethane.

Embodiment 17. The method of any of embodiments 1-16 wherein the aqueous film-forming composition comprises 2 to 7 wet weight percent fugitive plasticizer.

Embodiment 18. The method of any of embodiments 1-17 wherein the aqueous film-forming composition comprises 4 to 6 wet weight percent fugitive plasticizer.

Embodiment 19. The method of any of embodiments 1-18 wherein the aqueous film-forming composition comprises 2 to 25 dry weight percent wax.

Embodiment 20. The method of any of embodiments 1-19 wherein the aqueous film-forming composition comprises 3 to 10 dry weight percent wax.

Embodiment 21. The method of any of embodiments 1-20 wherein the aqueous film-forming composition comprises a water dispersible isocyanate.

Embodiment 22. The method of any of embodiments 1-21 wherein the aqueous film-forming composition contains substantially no condensable or crosslinkable silicates or condensable or crosslinkable polysilicates.

Embodiment 23. The method of any of embodiments 1-22 wherein the aqueous film-forming composition comprises less than about 2 wet weight percent organic solvent exclusive of the fugitive plasticizer.

Embodiment 24. The method of any of embodiments 1-23 wherein at least an acrylic polymer is present in the aqueous film-forming composition, comprising reversibly cross-linkable polymer groups.

Embodiment 25. The method of any of embodiments 1-24 wherein the aqueous film-forming composition comprises 0.2 to 1.5 wet weight percent tributoxyethyl phosphate.

Embodiment 26. The method of any of embodiments 1-25 wherein the aqueous film-forming composition comprises inorganic nanoparticles that have an average particle size (diameter) of 5-150 nm and that are surface modified.

Embodiment 27. The method of any of embodiments 1-26 wherein the substrate is a vinyl substrate comprising vinyl composite tile or continuous vinyl sheeting.

Embodiment 28. The method of any of embodiments 1-26 wherein the substrate is chosen from the group consisting of wood, concrete, stone or terrazzo.

Embodiment 29. The method of any of embodiments 1-28 wherein the burnishing of the first coating comprises the steps of burnishing the first coating with a first fibrous pad and thereafter burnishing the first coating with a second fibrous pad that is different from the first fibrous pad and that is less aggressive than the first fibrous pad.

Embodiment 30. The method of any of embodiments 1-29 where the total solids content of the coating is from 8 to 35 weight percent.

Embodiment 31. The method of any of embodiments 1-30 where the polyurethane is a polyurethane-acrylic hybrid polymer.

Embodiment 32. An aqueous film-forming composition comprising 15 to 85 dry weight percent polyurethane, 15 to 85 dry weight percent acrylic polymer at a weight ratio of between 1:5 and 5:1 with the polyurethane, and 1 to 12 wet weight percent fugitive plasticizer.

Embodiment 33. The aqueous film-forming composition of embodiment 32 comprising 30 to 65 dry weight percent polyurethane, 35 to 55 dry weight percent acrylic polymer at a weight ratio of between 1:1 and 1.6:1 with the polyurethane, and 4 to 6 wet weight percent fugitive plasticizer.

Embodiment 34. The aqueous film-forming composition of embodiment 32 with a composition as defined in any of embodiments 12-26.

### EXAMPLES

The materials listed in Table 1 were obtained:

TABLE 1

| Descriptor | Ingredient | Source |
|---|---|---|
| Ethyl | Diethylene Glycol Monoethyl Ether | Dow Chemical Co, |
| CARBITOL | (Fugitive plasticizer) | Midland, MI |
| DOWANOL | Dipropylene Glycol n-Propyl Ether | Dow Chemical Co, |
| DPnP | (Fugitive plasticizer) | Midland, MI |
| ALBERDINGK | Aliphatic polyurethane dispersion | Alberdingk Boley GmbH, |
| U9800 | (35% solids in water) | Krefeld, Germany |
| ALBERDINGK | Self-crosslinking acrylic dispersion | Alberdingk Boley GmbH, |
| AC 2728 | (42% solids in water) | Krefeld, Germany |
| TBEP | Tributoxyethyl phosphate | TCI America, |
| | (leveling agent/plasticizer) | Portland, OR |
| MICHEM | Polypropylene (wax) emulsion | Michelman, |
| Emulsion 94340 | (40% solids in water) | Blue Ash, OH |
| MICHEM | Ethylene acrylic acid copolymer (wax) | Michelman, |
| Emulsion 44730 | (30% solids in water) | Blue Ash, OH |
| MICHEM | Polyethylene (wax) emulsion | Michelman, |
| Lube 190 | (35% solids in water) | Blue Ash, OH |
| SWCP-K | Silicone-anionic surfactant | Lambert Technologies, |
| | (40% solids in water) | Orem, UT |

Four representative formulations (A, B, C, and D) were made, by mixing the ingredients together as shown in Table 2, using standard laboratory methods. All formulations were made in batches of approximately 100 grams; ingredients are listed in Table 2 on a wet percent basis.

TABLE 2

| Formulation | A | B | C | D |
|---|---|---|---|---|
| Ethyl | 4.5 | 4.0 | 4.5 | 4.5 |
| CARBITOL | | | | |
| DOWANOL | 0.0 | 0.5 | 0.0 | 0.0 |
| DPnP | | | | |
| ALBERDINGK | 25 | 25 | 25 | 25 |
| U9800 | | | | |
| ALBERDINGK | 25 | 25 | 25 | 25 |
| AC 2728 | | | | |
| TBEP | 2.1 | 2.1 | 2.1 | 2.1 |
| MICHEM | 2.5 | 2.5 | 4.0 | 0.0 |
| Emulsion 94340 | | | | |
| MICHEM | 0 | 0 | 0 | 7.0 |
| Emulsion 44730 | | | | |
| MICHEM | 2.5 | 2.5 | 4.0 | 0.0 |
| Lube 190 | | | | |
| SWCP-K | 0.8 | 0.8 | 0.8 | 0.8 |
| Water | 37.6 | 37.6 | 34.6 | 35.6 |

Thus, with regard to Formulation A, fugitive plasticizer ethyl CARBITOL was present in the formulation at approximately 4.5 wet weight percent; polyurethane was present (as added in the ALBERDINGK U9800, in which the polyurethane was provided at approximately 35% solids) in the formulation at 8.75 wet weight percent. The total percent solids of formulation A was approximately 23.6%, with polyurethane comprising approximately 37 dry weight percent (with reference to the final dried film).

### Example Set 1

Each formulation (A-D) was coated onto a separate vinyl composite tile by the following process. 12 inch vinyl composite tiles (Armstrong) were obtained from Home Depot. Each tile was preburnished with a 6″ diameter SCOTCH-BRITE PURPLE DIAMOND FLOOR PAD PLUS from 3M Company, followed by preburnishing with a 6″ WHITE SUPER POLISH 4100 pad from 3M Company. The pads were mounted on, and driven by, an electrically powered tool obtained from 3M Company under the trade designation Electric Variable Speed Polisher 28391, running at 3000 RPM. Four passes were performed on each tile, with each pass being a forward and backward motion across the tile.

Each formulation was then coated onto a separate tile using conventional manual coating methods, at a coverage rate estimated to be approximately 3000 square feet per gallon. Each coating was allowed to dry for approximately 25 minutes (at which point it was not sticky or tacky to the touch) and was then burnished using four passes of a SCOTCH-BRITE PURPLE DIAMOND FLOOR PAD PLUS followed by four passes with a WHITE SUPER POLISH 4100 pad (again using the 28931 powered apparatus). A second coating was then applied immediately thereafter (for each tile, the second coating was the same formulation as the first).

All of the tiles exhibited an excellent gloss level (e.g. with a glass level at or above 60 being consistently obtained using a Micro-TRI-Gloss meter obtained from BYK Gardner, Columbia, Md.). This level of gloss was judged to be comparable to that achieved by the application of three or four coatings of conventional acrylic floor finish.

### Gloss Retention

Example 1 tiles with dried coatings thereupon were evaluated for gloss retention after having been wet scrubbed (e.g., to simulate wear, scuffing, abrasion, etc.) according to the following procedure. The gloss of each coated tile was measured (with, typically, five individual measurements being averaged). Then, the tiles were wet scrubbed, with a separate tile coated with each formulation being scrubbed with, in one case, a portion of a 3M Floor Pad Red Buffer 5100 used in conjunction with 3M Twist'n Fill 3H (neutral cleaner); and, in another case, with a portion of a 3M Blue Cleaner 5300 (pad), again used in conjunction with 3M Twist'n Fill 3H neutral cleaner. In both cases, portions of the pad were mounted onto a Scrub Abrasion Resistance Tester obtained from BYK Gardner, with the Abrasion Resistance Tester being used to drive the pad portion (in the presence of the neutral cleaner liquid) across the tested portion of the tile, at least 100 times. The scrubbed tiles were then reburnished in similar manner as described above. Gloss values for the scrubbed-reburnished tile samples were then measured, and are listed in Table 3, with gloss retention being ratio of the post-scrub/reburnished gloss to the pre-scrub gloss, presented in percent (a value of 100 thus represents no change in gloss due to scrubbing). Excellent retention of gloss was observed. It is noted that the increase in gloss with use of the 3M Floor Pad Red Buffer 5100 was not unexpected since this product is designated as a “buffer” (rather than a more aggressive, e.g. abrasive, pad of the type exemplified by 3M Blue Cleaner 5300); such buffer may merely serve to increase the gloss of the coated finish rather than to aggressively remove at least a portion of the finish, as might be expected e.g. with the 3M blue Cleaner. In any case, it is clear that good retention of gloss is evidenced.

TABLE 3

| Formulation | A | B | C | D |
|---|---|---|---|---|
| Red Buffer | 99 | 104 | 120 | 103 |
| Blue Cleaner | 85 | 89 | 94 | 87 |

### Example Set 2

In another experiment, another new vinyl composite tile was obtained and was chemically stripped using 3M Twist'n Fill #6 stripper to remove any existing coating (finish) that might be present. The stripped tile was then rinsed to remove any residual cleaner and dried, but was not burnished. One coating of formulation A was then applied and was allowed to dry for approximately 30 minutes. The coating was then burnished using five passes of a SCOTCH-BRITE PURPLE DIAMOND FLOOR PAD PLUS followed by five passes with a WHITE SUPER POLISH 4100 pad (again using the 28931 powered apparatus). A second coating of formulation A was then immediately applied, and was not burnished. While not exhibiting as good a gloss as the Example 1 tiles (which had been were pre-burnished before coating the formulations thereupon), the coated/burnished tile of Example 2 still exhibited acceptable gloss (and general appearance).

The tests and test results described above are intended solely to be illustrative, rather than predictive, and variations in the testing procedure can be expected to yield different results. All quantitative values in the Examples section are understood to be approximate in view of the commonly known tolerances involved in the procedures used. The foregoing detailed description and examples have been given for clarity of understanding only. No unnecessary limitations are to be understood therefrom.

It will be apparent to those skilled in the art that the specific exemplary structures, features, details, configurations, etc., that are disclosed herein can be modified and/or combined in numerous embodiments. All such variations and combinations are contemplated by the inventor as being within the bounds of the conceived invention. Thus, the scope of the present invention should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control.

What is claimed is:

1. A method of forming a coating, comprising:
coating an aqueous film-forming composition comprising 15 to 100 dry weight percent polyurethane and comprising 1 to 12 wet weight percent fugitive plasticizer, onto a surface of a substrate to form a first coating thereupon; and, allowing the coating to dry; then,
burnishing the first coating within sixty minutes of forming the first coating.

2. The method of claim 1 further comprising the step of coating an aqueous film-forming composition comprising 15 to 100 dry weight percent polyurethane and comprising 1 to 12 wet weight percent fugitive plasticizer, onto an outwardmost surface of the burnished first coating, to form a second coating thereupon.

3. The method of claim 2 wherein the aqueous film-forming composition of claim 2 is of the same composition as the aqueous film-forming composition of claim 1.

4. The method of claim 2 with the proviso that the second coating is not burnished and is a top coating with no other coatings being formed thereupon.

5. The method of claim 2 further comprising the step of burnishing the second coating.

6. The method of claim 5 further comprising the step of forming a top coating directly or indirectly upon the burnished second coating, with the proviso that the top coating is not burnished.

7. The method of claim 1 comprising the step of burnishing the surface of the substrate before coating the aqueous film-forming dispersion thereupon to form the first coating.

8. The method of claim 1 wherein the aqueous film-forming composition comprises 30 to 65 dry weight percent polyurethane.

9. The method of claim 1 wherein the aqueous film-forming composition comprises 25 to 85 dry weight percent acrylic polymer at a weight ratio of between 1:4 and 4:1 with the polyurethane.

10. The method of claim 9 wherein the acrylic polymer is a self-crosslinking acrylic polymer.

11. The method of claim 1 wherein the aqueous film-forming composition comprises 40 to 50 dry weight percent acrylic polymer at a weight ratio of between 1:1 and 1.6:1 with the polyurethane.

12. The method of claim 1 wherein the aqueous film-forming composition comprises 2 to 7 wet weight percent fugitive plasticizer.

13. The method of claim 1 wherein the aqueous film-forming composition comprises 4 to 6 wet weight percent fugitive plasticizer.

14. The method of claim 1 wherein the aqueous film-forming composition comprises 2 to 25 dry weight percent wax.

15. The method of claim 1 wherein the aqueous film-forming composition comprises inorganic nanoparticles that have an average particle size (diameter) of 5-150 nm and that are surface modified.

16. The method of claim 1 wherein the substrate is a vinyl substrate comprising vinyl composite tile or continuous vinyl sheeting.

17. The method of claim 1 wherein the substrate is chosen from the group consisting of wood, concrete, stone or terrazzo.

18. The method of claim 1 wherein the burnishing of the first coating comprises the steps of burnishing the first coating with a first fibrous pad and thereafter burnishing the first coating with a second fibrous pad that is different from the first fibrous pad and that is less aggressive than the first fibrous pad.

19. The method of claim 1 where the polyurethane is a polyurethane-acrylic hybrid polymer.

20. An aqueous film-forming composition comprising 15 to 85 dry weight percent polyurethane, 15 to 85 dry weight percent acrylic polymer at a weight ratio of between 1:5 and 5:1 with the polyurethane, and 1 to 12 wet weight percent fugitive plasticizer.
